(19) United States
(12) Patent Application Publication
(10) Pub. No.: US 2012/0223540 A1
(43) Pub. Date: Sep. 6, 2012

(54) Recreational Vehicle Lift Mechanism

(75) Inventor: James R. Peck, Goshen, IN (US)

(73) Assignee: L&W ENGINEERING, INC., Middlebury, IN (US)

(21) Appl. No.: 13/037,522

(22) Filed: Mar. 1, 2011

(51) Int. Cl. B62D 33/08

(52) U.S. Cl. 296/26.04; 254/92

(57) ABSTRACT

A lift mechanism for raising and lowering a movable roof on a recreational vehicle. The lift mechanism includes a base, a drive assembly attached to the base, and an elevation assembly attached to the base and configured for cooperation with the drive assembly. The elevation assembly is configured to operate between a lowered position and a raised position to provide vertical movement to the movable roof.

### BACKGROUND AND SUMMARY OF THE INVENTION

The present invention relates to a lift mechanism. More particularly, the present invention relates to a lift mechanism for raising and lowering a movable roof, for example on a recreational vehicle. Recreational vehicles include tent campers, travel trailers, fifth-wheels, toy haulers and other vehicles that generally have an interior space for living and sleeping. To increase the amount of interior space, some recreational vehicles include a “pop-up” top or roof that can be raised when the recreational vehicle is stationary and that can be lowered when the recreational vehicle is to be moved. The present disclosure provides a lift mechanism for raising and lowering a movable roof on a recreational vehicle.

In one embodiment of the present invention, a lift mechanism includes a base, a drive assembly, and a pair of elevation assemblies. The base includes a track and a drive mount. The drive assembly includes a driver attached to the drive mount and a threaded drive shaft coupled to the driver. The pair of elevation assemblies are disposed in a mirrored configuration relative to each other on opposite ends of the base. Each elevation assembly includes a slide block configured to move linearly in cooperation with the track of the base, a support arm that is pivotally connected to the base at a first end, and a lift arm pivotally coupled to the second end of the support arm. The slide block includes a roller attached to the top of the slide block at one end, a slot disposed along each side of the slide block, a slide stop positioned within each slot at another end of the slide block, and a bore extending through the slide block in a direction corresponding to a longitudinal axis thereof. The bore through the slide block includes a thread configured for cooperation with the threaded drive shaft. The support arm includes a lift member disposed on a lower side of the support arm at a second end. The lift member includes a cam surface configured for cooperation with the roller attached to the top of the slide block. The lift arm is pivotally coupled to the second end of the support arm at a location between a first end of the lift arm and a second end of the lift arm. The lift arm includes a pair of pins attached to the first end of the lift arm, the pins extending inwardly and configured for cooperation with the slots disposed along each side of the slide block. The elevation assemblies are configured to operate in synchronism between a lowered position and a raised position to provide substantially vertical movement to an object attached to the second ends of the lift arms without tilting the object. Further, the elevation assemblies are configured such that upon initial movement from a lowered position, outward movement of the slide blocks causes the rollers attached thereto to engage the cam surfaces of the lift members providing cam-assisted vertical movement to the second ends of the lift arms. After the initial movement, the rollers disengage the cam surfaces and the slide stops engage the pins on the first ends of the lift arms continuing the vertical movement of the second ends of the lift arms.

In another embodiment of the present invention, a lift mechanism includes a base, a drive assembly attached to the base, and an elevation assembly attached to the base and configured for cooperation with the drive assembly. The elevation assembly includes a slide block coupled to the drive assembly that is configured to move linearly along the base. The elevation assembly further includes a support arm that is pivotally connected to the base at a first end and that includes a cam surface disposed on the support arm at a second end. The cam surface is configured for cooperation with the slide block. The elevation assembly further includes a lift arm that is pivotally coupled to the second end of the support arm at a location between a first end of the lift arm and a second end of the lift arm. The first end of the lift arm is coupled to the slide block. The elevation assembly is configured to operate between a lowered position and a raised position to provide vertical movement to the second end of the lift arm. Further, upon initial movement from a lowered position, movement of the slide block cooperates with the cam surface to provide cam-assisted vertical movement to the second end of the lift arm.

In yet another embodiment of the present invention, a system for raising and lowering a movable roof on a vehicle includes at least one lift mechanism. The lift mechanism includes a base mounted on the vehicle, a drive assembly attached to the base, and a pair of elevation assemblies attached to the base. Each elevation assembly includes a slide block coupled to the drive assembly and configured to move linearly along the base. Further, each elevation assembly includes a support arm that is pivotally connected to the base at a first end and includes a cam surface disposed on the support arm at a second end, wherein the cam surface is configured for cooperation with the slide block. Also, each elevation assembly includes a lift arm that is pivotally coupled to the second end of the support arm at a location between a first end of the lift arm and a second end of the lift arm. The first end of the lift arm is coupled to the slide block. The elevation assemblies are configured to operate in synchronism between a lowered position and a raised position to provide substantially vertical movement to an object attached to the second ends of the lift arms without tilting the object. Further, the elevation assemblies are configured such that upon initial movement from a lowered position, the slide blocks move outwardly thereby engaging the cam surfaces to provide cam-assisted vertical movement to the second ends of the lift arms. Further, after the initial movement, the slide blocks disengage the cam surfaces and the slide blocks engage the first ends of the lift arms, thereby continuing the vertical movement of the second ends of the lift arms.

### BRIEF DESCRIPTION OF THE DRAWINGS

The present disclosure will be described hereafter with reference to the attached drawings which are given as non-limiting examples only, in which:

FIG. 1 is a perspective view of a lift mechanism according to one embodiment of the present invention shown in a retracted or lowered position;

FIG. 2 is a perspective view of the lift mechanism of FIG. 1 shown in an extended or raised position with an exploded view of one of the elevation assemblies;

FIG. 3 is a detailed exploded view of the are indicated in detail 3-3 of FIG. 2;

FIG. 4 is a perspective view a base that is a component of the lift mechanism of FIG. 1;

FIG. 5 is a perspective view of a slide block that is a component of the lift mechanism of FIG. 1;

FIG. 5A is a perspective view of an alternative embodiment of a slide block that is a component of the lift mechanism of FIG. 1;

FIG. 5B is a top view of the alternative embodiment of the slide block of FIG. 5A;

FIG. 5C is an end view of the alternative embodiment of the slide block of FIG. 5A;

FIG. 5D is a side view of the alternative embodiment of the slide block of FIG. 5A;

FIG. 6 is a perspective view of the underside of a support that is a component of the lift mechanism of FIG. 1;

FIG. 7 is a perspective view of the underside of a lift arm that is a component of the lift mechanism of FIG. 1;

FIGS. 8A and 8B are detailed views of the slide block configuration for the lift mechanism of FIG. 1 showing initiation of cam-assisted lift action for the elevation assembly;

FIGS. 9A and 9B are detailed views of the slide block configuration for the lift mechanism of FIG. 1 showing completion of cam-assisted lift action for the elevation assembly;

FIG. 10 is a perspective representation of a recreational vehicle including the lift mechanism of FIG. 1 in a retracted or lowered position;

FIG. 11 is a perspective representation of a recreational vehicle including the lift mechanism of FIG. 1 in an extended or raised position;

FIG. 12 is a detailed cross-sectional view taken at 12-12 in FIG. 10; and

FIG. 13 is a detailed cross-sectional view taken at 13-13 in FIG. 11.

### DETAILED DESCRIPTION OF EMBODIMENTS OF THE INVENTION

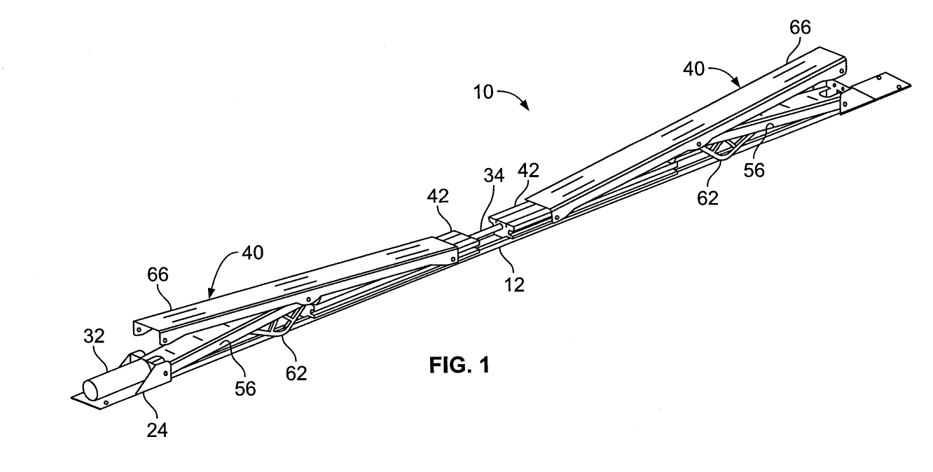

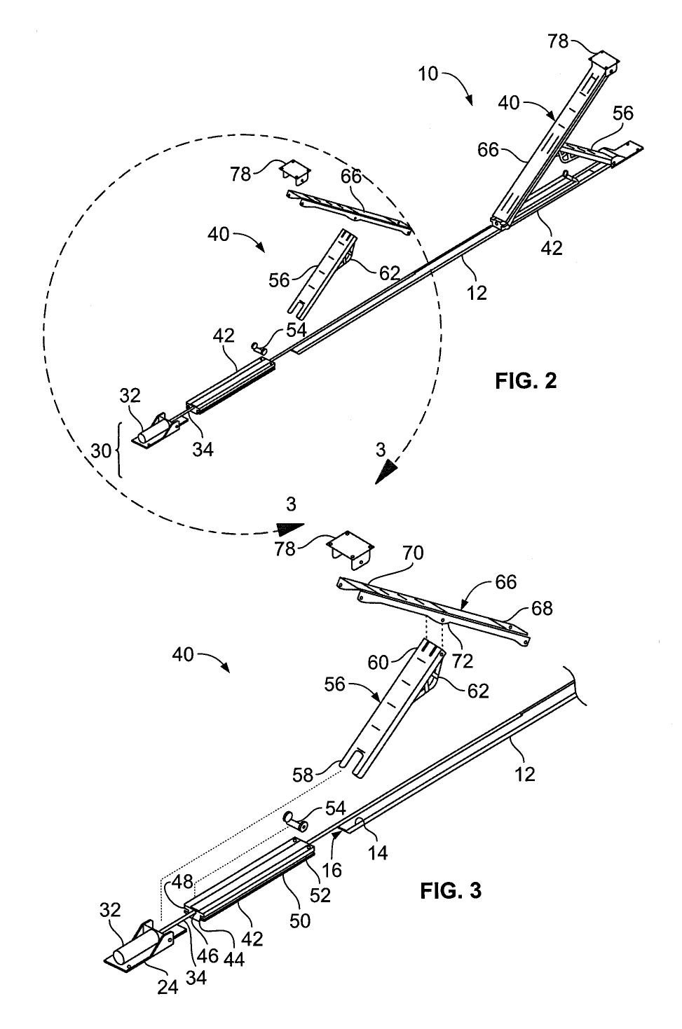

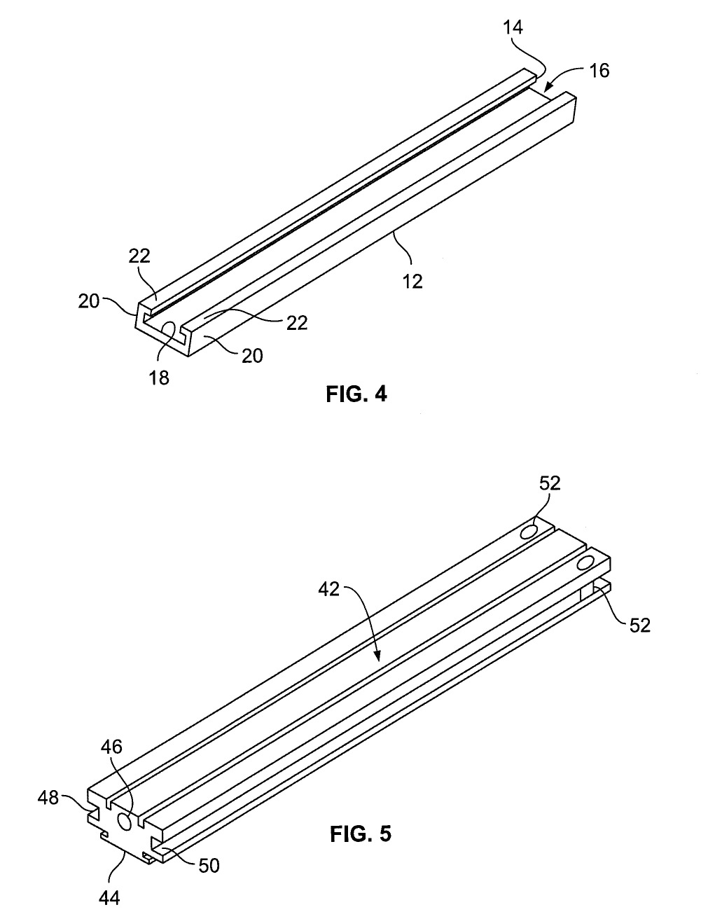

FIGS. 1 and 2 show a lift mechanism 10 according to one embodiment of the present invention. In this embodiment, lift mechanism 10 includes a base 12, a drive assembly 30 and an elevation assembly 40. Referring now to FIG. 4, the base 12 includes a track 14 having a channel 16 defined by a floor 18, a pair of sidewalls 20 extending from the floor, and a pair of retainers 22 disposed on the sidewalls 20 opposite and spaced apart from the floor 18 and extending inwardly from the sidewalls 20. In the exemplary embodiment shown in FIG. 4, the base 12 has the general cross-sectional shape of a C-channel. A drive mount 24 may be provided at one end of the base 12 as shown in FIGS. 1 and 2.

Drive assembly 30 includes a driver 32 such as an electric, pneumatic, or hydraulic motor, or the like, configured to be attached to the drive mount 24. A threaded drive shaft 34 is coupled to the driver 32 and extends along the length of the base 12 above the track 14. Although not shown, drive assembly 30 may also include a gear assembly or gear box disposed between the driver 32 and the threaded drive shaft 34 to control the speed and/or torque output of the drive assembly.

In the exemplary embodiment shown in FIGS. 1 and 2, the lift mechanism 10 includes two elevation assemblies 40, one disposed at each end of the base 12, which are configured as mirror images of each other. For simplicity, only one of the elevation assemblies 40 will be described, however it should be understood that the description and reference numbers apply to both. Referring to FIG. 3, elevation assembly 40 includes a slide block 42 configured to cooperate with the track 14, a support arm 56 pivotally coupled to the base 12 at one end, and a lift arm 66 pivotally coupled to the support arm 56 and configured to engage the slide block 42 in a sliding manner.

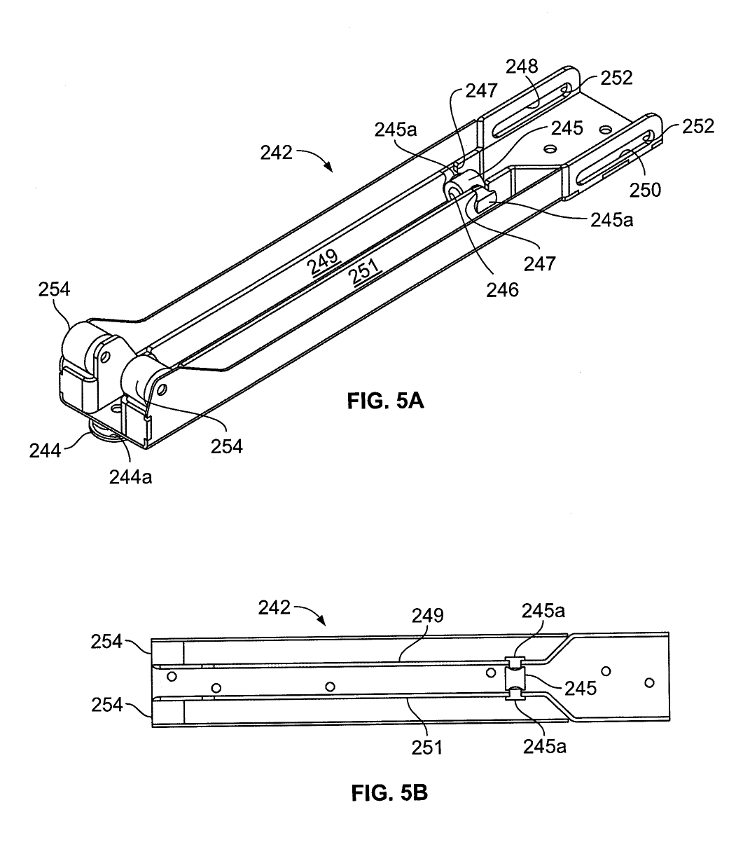

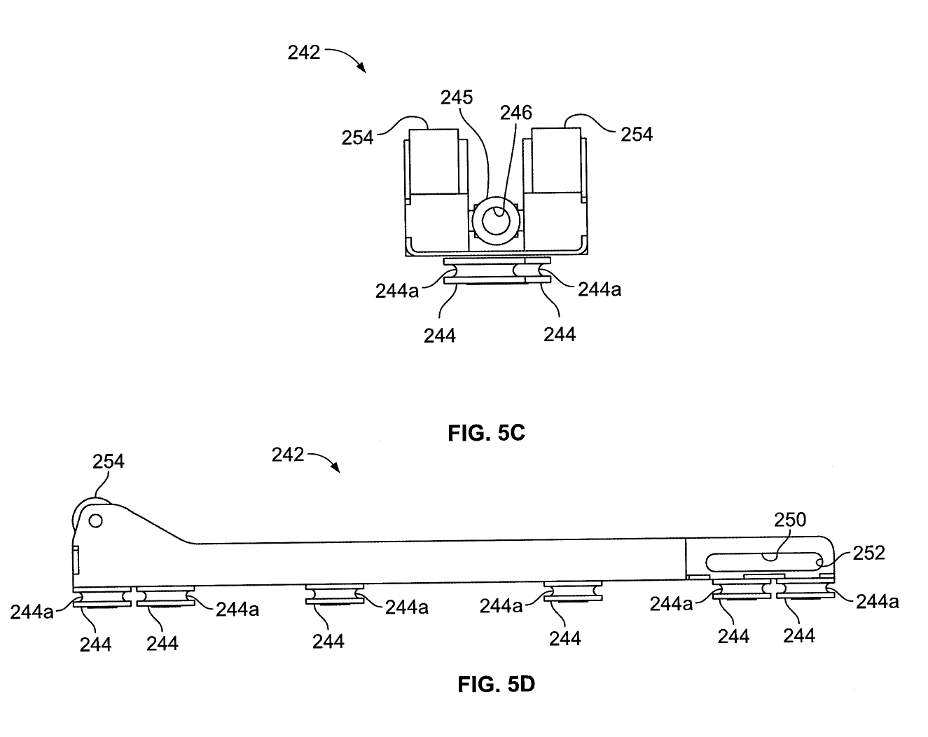

Referring to FIG. 5, the slide block 42 includes a flange 44 configured to cooperate with and engage the channel 16 of track 14 so as to be able to slide therein, allowing for linear movement of the slide block 42 along track 14. Slide block 42 also includes a threaded bore 46 extending in the same direction as the longitudinal axis thereof, which is configured for cooperation with the threaded drive shaft 34. Slide block 42 also includes a pair of slots or grooves 48, 50 disposed along either side of the slide block 42. Slide stops 52 are disposed within each groove 48, 50 at one end of the slide block 42. Rollers 54 are attached to the top of the slide block 42 on the end opposite slide stops 52. In the exemplary embodiment, the slide block 42 is positioned in the track 14 such that the slide stops 52 are located on the inboard end of the slide block 42 and the rollers 54 are located on the outboard end of the slide block 42.

In an alternate embodiment shown in FIGS. 5A-D, the slide block 242 includes a plurality of guide rollers 244 mounted horizontally on the bottom of the slide block 242 and configured to engage the retainers 22 of track 14 shown in FIG. 4. Each guide roller 244 includes a groove 244a disposed about the circumference of the roller. The roller grooves 244a are configured to receive opposed edges of retainers 22 thereby allowing the slide block 242 to move along track 14. Slide block 242 also includes a nut 245 having a threaded bore 246 extending in the same direction as the longitudinal axis of the slide block. The threaded bore 246 is configured for cooperation with the threaded drive shaft 34. Nut 245 includes mounting arms 245a. Mounting arms 245a are configured to cooperate with mounting notches 247 formed in webs 249, 251. In an exemplary embodiment, threaded bore 246 is configured with an ACME thread adapted to engage a corresponding ACME thread on drive shaft 34.

Slide block 242 also includes a pair of slots 248, 250 disposed along either side of the slide block 242. Rollers 254 are attached to the top of slide block 254 on the end opposite slots 248, 250. In an exemplary embodiment, the slide block is positioned in the track 14 such that the slots 248, 250 are located on the inboard end of the slide block 242 and the rollers are located on the outboard end of the slide block 242.

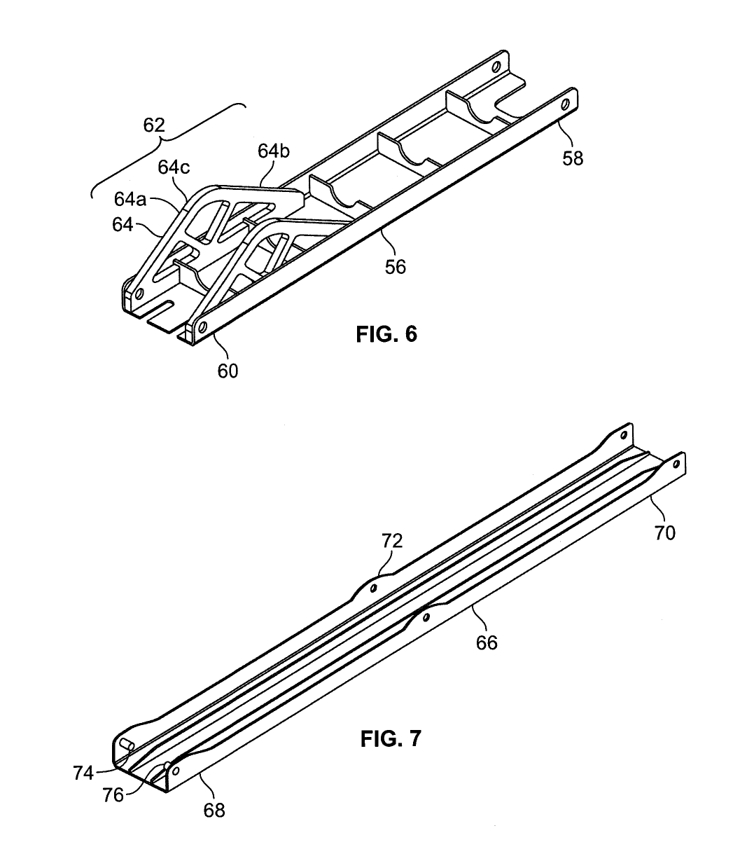

Referring again to FIG. 3, elevation assembly 40 also includes a support arm 56 having a first end 58 and a second end 60. The first end 58 of support arm 56 is pivotally coupled to the base 12. The second end 60 of support arm 56 includes a lift member 62 on the lower side thereof. Referring to FIG. 6, the lift member 62 includes a cam surface 64 formed by a first leg 64a and a second leg 64b that is configured to cooperate with the rollers 54 on the slide block 42.

Lift arm 66, including a first end 68 and a second end 70, is pivotally coupled to the second end 60 of the support arm 56 at an intermediate location 72 between the first end 68 of the lift arm 66 and the second end 70 of the lift arm 66. Referring to FIG. 7, the first end 68 of the lift arm 66 includes lift arm pins 74, 76, which extend inwardly and are configured for cooperation with the slots or grooves 48, 50 disposed along the sides of slide block 42. A bracket 78 may be provided at the second end 70 of lift arm 66 for attachment to a frame member or other object that is to be lifted by the lift mechanism 10 of the present invention. As shown in FIG. 1, when the lift mechanism 10 of the present invention is in a retracted or lowered configuration, lift arm 66 is disposed over the support arm 56 and the slide block 42 in a relatively compact arrangement.

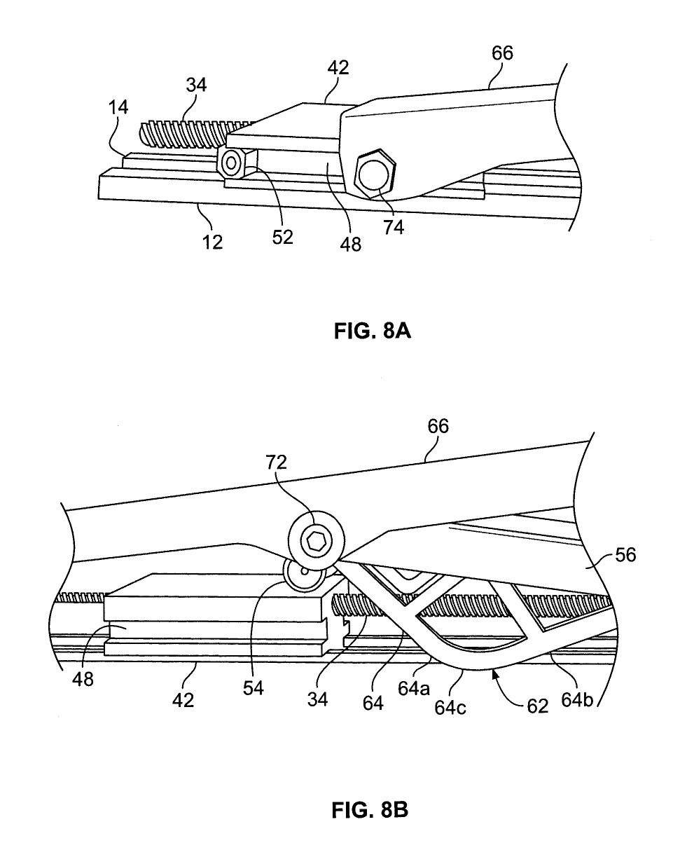

Referring again to FIG. 1, when this embodiment of the lift mechanism 10 of the present invention is in a retracted or lowered configuration, the elevation assemblies 40 are configured with the slide blocks 42 positioned at a medial or inboard location within the track 14 of the base 12. In this lowered position, lift arm pins 74, 76 are positioned within grooves 48, 50 in slide block 42, as shown in FIG. 8A. Slide stops 52 are spaced apart from and out of contact with the lift arm pins 74, 76. Also, rollers 54 are positioned such that they are in contact with the cam surface 64 of the lift member 62 as shown in FIG. 8B.

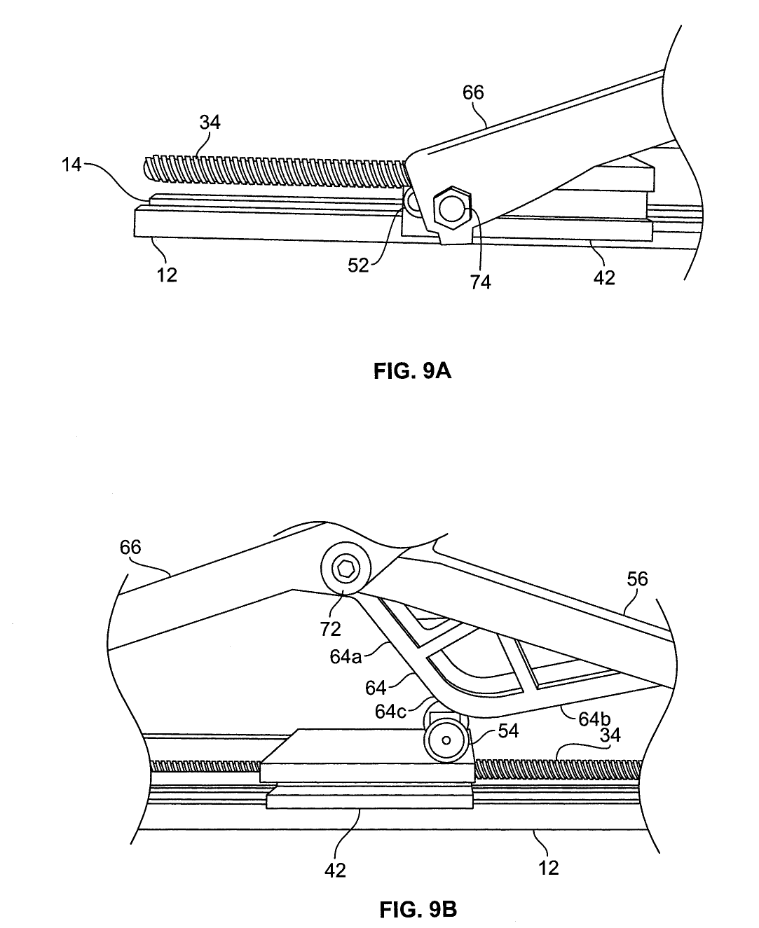

In operation to move the lift mechanism 10 to an extended or raised configuration, drive assembly 30 is engaged such that driver 32 imparts a torque on the threaded drive shaft 34 causing the threaded drive shaft 34 to rotate. As the threaded drive shaft 34 rotates it engages the threaded bore 46 in the slide blocks 42, thereby moving slide blocks 42 outwardly along track 14. As the slide blocks 42 move outwardly, rollers 54 move along cam surface 64 of lift member 62 providing a cam-assisted vertical lift action by causing support arm 56 to pivot upwardly until rollers 54 reach a cusp 64c on the cam surface 64 as shown in FIG. 9B. At this point, slide stops 52 engage lift arm pins 74, 76, as shown in FIG. 9A. As slide blocks 42 continue to move outwardly, slide stops 52 push outwardly against lift arm pins 74, 76 causing lift arm 66 to pivot about point 72 and also causing support arm 56 to continue to pivot upwardly. Slide blocks 42 continue to move outwardly until support arm 56 and lift arm 66 are in their respective fully extended positions. In this embodiment of the invention, the configuration of lift arm 66 being pivotally coupled to the support arm 56 at point 72 and also being engaged with the slide block 42 at its first end 68 in the manner shown results in substantially vertical movement of the second end 70 of lift arm 66. That is, second end 70 does not move in an arc or tilting manner.

An embodiment of the present invention having a slide block 242 as shown in FIG. 5A operates in a similar manner as that previously described. Threaded drive shaft 34 rotates engaging the corresponding threads in the threaded bore 246 of nut 245, thereby moving slide blocks 242 outwardly along track 14. As the slide blocks 242 move outwardly, rollers 254 move along cam surface 64 of lift member 62 providing a cam-assisted vertical lift action by causing support arm 56 to pivot upwardly until rollers 254 reach a cusp 64c on the cam surface 64 as previously described. At this point, the ends 252 of slots 248, 250 act as slide stops to engage lift arm pins 74, 76, as previously described. As slide blocks 242 continue to move outwardly, slot ends 252 push outwardly against lift arm pins 74, 76 causing lift arm 66 to pivot about point 72 and also causing support arm 56 to continue to pivot upwardly. Slide blocks 242 continue to move outwardly until support arm 56 and lift arm 66 are in their respective fully extended positions.

To return the lift mechanism 10 to its retracted position, the rotation of the threaded drive shaft 34 is reversed, driving slide blocks 42, 242 inwardly along track 14. As slide blocks 42, 242 move inwardly, support arm 56 and lift arm 66 pivot downwardly about their pivot points until slide blocks 42, 242 are positioned at the original inboard location in track 14 and the elevation assembly 40 is in the lowered position.

As should be apparent, slide blocks 42, 242 and drive shaft 34 are configured such that slide blocks 42, 242 move outwardly and inwardly together in synchronism. In the exemplary embodiments, the threaded bores 46, 246 in each slide block 42, 242 are threaded in a different direction (i.e. one slide block has a right handed thread and the other slide block has a left handed thread) with the corresponding portion of the threaded drive shaft 34 being configured to cooperate with the respective slide block bores 46, 246.

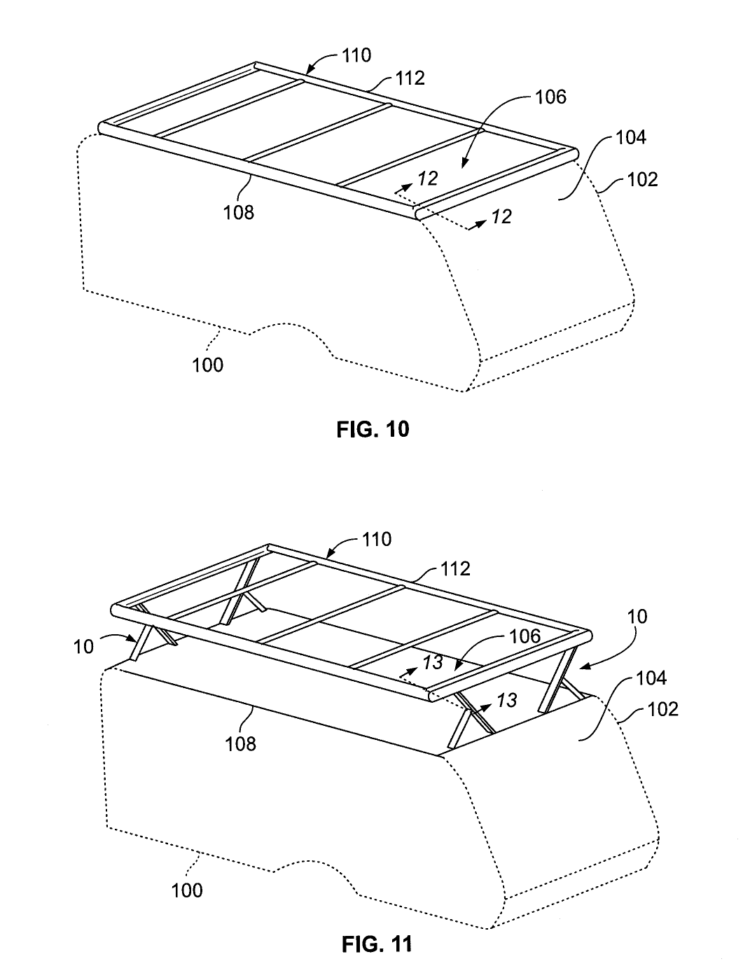

The lift mechanism 10 of the present invention may be employed, for example, to raise and lower an adjustable roof as in a recreational vehicle. Referring to FIGS. 10 and 11, a recreational vehicle 100 includes a body 102 and a roof 104. An opening 106 is provided in the roof 104. A frame 108 may be provided around the periphery of opening 106. In the exemplary embodiment shown in FIGS. 10 and 11, frame 108 is constructed from angle iron attached to the roof 104.

Referring to FIG. 11, the exemplary embodiment includes two lift mechanisms 10 of the present invention, mounted on the frame 108. One lift mechanism 10 is mounted on a forward portion of frame 108 and one lift mechanism 10 is mounted on an aft portion of frame 108. However, mounting the lift mechanisms 10 on the sides of frame 108 would be equally acceptable and would not depart from the scope of the present disclosure.

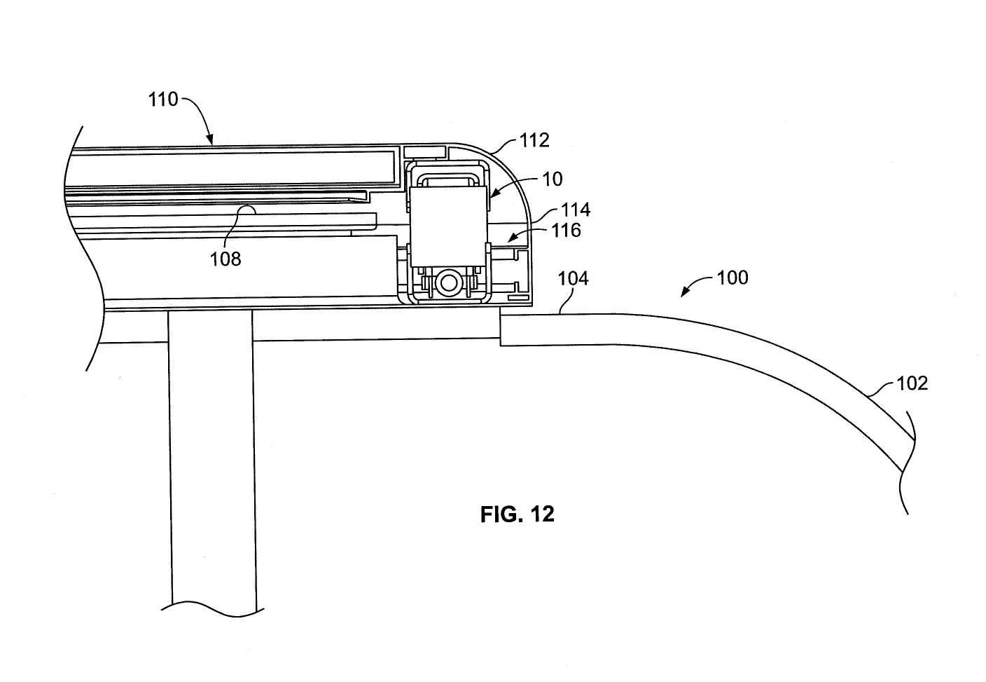

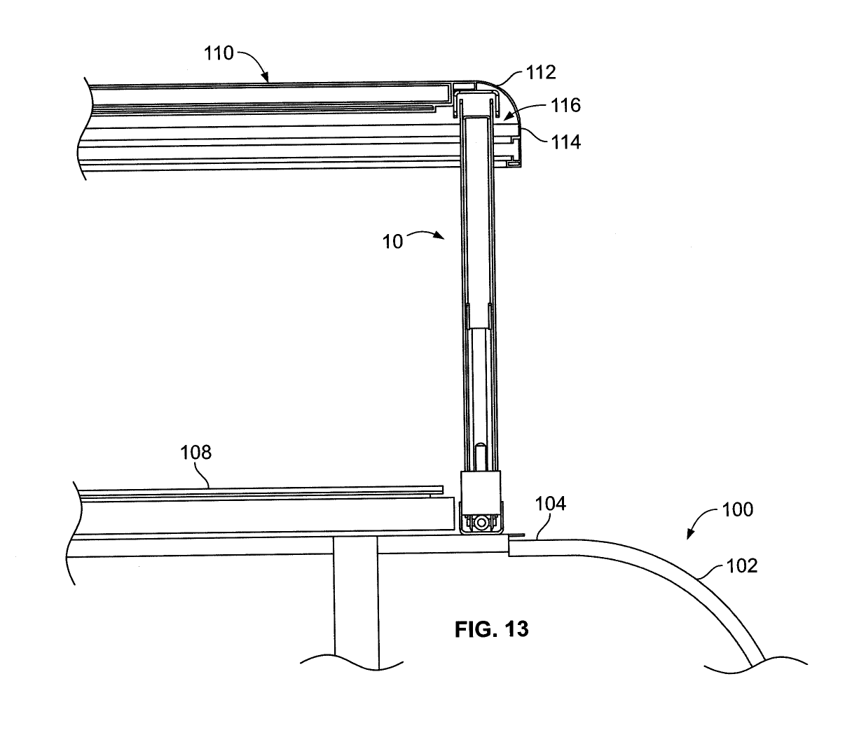

A movable roof frame 110 is mounted on the lift mechanisms 10 by brackets 78, see FIGS. 2 and 3. Movable roof frame 110 may include a cap 112 having a downwardly extending lip portion 114 defining a recess 116. The recess 116 is configured to fit over and cover frame 108 and lift mechanisms 10 when the movable roof frame 110 is in a lowered or retracted position, as shown in FIG. 12, providing a compact enclosure. When the movable roof frame 110 is in the retracted position, the downwardly extending lip portion 114 provides an enclosure protecting the lift mechanisms 10 and frame 108 from environmental contaminants such as dust, dirt, precipitation, and the like.

Movable roof frame 110 may include flexible panels (not shown) attached to the frame 108 and the movable roof frame 110 configured to provide an extendable flexible wall between the frame 108 and the movable roof frame 110 when the movable roof frame is in a raised position. Also, the flexible panels may be configured to fold away for storage when the movable roof frame is in a lowered position. Additionally, the movable roof frame 110 may include one or more flexible or rigid horizontal roof panels (not shown).

The lift mechanism 10 of the present disclosure allows for vertically raising and lowering a movable roof frame 110 on a recreational vehicle 100 without tilting. The configuration of the lift member 62 and rollers 54, 254 on the slide block 42, 242 provide an initial cam-assisted vertical movement of lift mechanism 10, wherein the laterally outward movement of the rollers 54, 254 on the slide block 42, 242 cooperate with cam surface 64 to assist support arm 56, and consequently lift arm 66, to pivot upward, until the slide stops 54 engage the lift arm pins 74, 76, which then drive lift arm 66 to its extended position.

While preferred embodiments of the present invention are shown and described, it is envisioned that those skilled in the art may devise various modifications of the present invention without departing from the spirit and scope of the appended claims.

We claim:

1. A lift mechanism comprising:
a base including a track and a drive mount;
a drive assembly including a driver attached to the drive mount and a threaded drive shaft coupled to the driver; and
a pair of elevation assemblies, each elevation assembly disposed in a mirrored configuration relative to the other on opposite ends of the base, each elevation assembly including
a slide block configured to linearly move in cooperation with the track of the base, the slide block including,
a roller attached to the top of the slide block at a first end,
a slot disposed along each side of the slide block,
a slide stop positioned within each slot at a second end of the slide block, and
a bore extending in a direction corresponding to a long axis of the slide block, the bore including a thread configured for cooperation with the threaded drive shaft,
a support arm having a first end and a second end, the support arm being pivotally connected to the base at the first end and including a lift member disposed on a lower side of the support arm at the second end, wherein the lift member includes a cam surface configured for cooperation with the roller attached to the top of the slide block, and
a lift arm having a first end and a second end, the lift arm being pivotally coupled to the second end of the support arm at a location between the first end of the lift arm and the second end of the lift arm, the lift arm including
a pair of pins attached to the first end of the lift arm, the pins extending inwardly and configured for cooperation with the slots disposed along each side of the slide block;
wherein the elevation assemblies are configured to operate in synchronism between a lowered position and a raised position to provide substantially vertical movement to an object attached to the second ends of the lift arms without tilting the object, and wherein the elevation assemblies are configured such that initial outward movement of the slide blocks causes the rollers attached thereto to engage the cam surfaces of the lift members providing cam-assisted vertical movement to the second ends of the lift arms, and wherein after the initial movement, the rollers disengage the cam surfaces and the slide stops engage the pins on the first ends of the lift arms continuing the vertical movement of the second ends of the lift arms.

2. A lift mechanism comprising:
a base;
a drive assembly attached to the base; and
an elevation assembly attached to the base and configured for cooperation with the drive assembly, the elevation assembly including
a slide block coupled to the drive assembly and configured to move linearly along the base,
a support arm having a first end and a second end, the support arm being pivotally connected to the base at the first end and including a cam surface disposed on the support arm at the second end configured for cooperation with the slide block, and
a lift arm having a first end and a second end, the lift arm being pivotally coupled to the second end of the support arm at a location between the first end of the lift arm and the second end of the lift arm, the first end of the lift arm coupled to the slide block,
wherein the elevation assembly is configured to operate between a lowered position and a raised position to provide vertical movement to the second end of the lift arm, and wherein upon initial movement of the slide blocks when the elevation assembly is in a lowered position, the slide block cooperates with the cam surface to provide cam-assisted vertical movement to the second end of the lift arm.

3. The lift mechanism of claim 2 wherein the drive assembly includes a driver coupled to a drive shaft.

4. The lift mechanism of claim 3 wherein the drive shaft includes a screw thread disposed about the drive shaft, the screw thread configured for cooperation with a bore disposed within the slide block.

5. The lift mechanism of claim 3 wherein the driver is selected from the group consisting of an electric motor, a pneumatic motor, and a hydraulic motor.

6. The lift mechanism of claim 2 wherein the slide block includes first and second slots, one slot disposed along each side of the slide block, the first and second slots being configured to receive a first pin and a second pin disposed on the first end of the lift arm for slidable engagement of the slide block and the lift arm.

7. The lift mechanism of claim 6 including a slide stop positioned within each of the first and second slots on the slide block, each slide stop configured to engage a pin on the first end of the lift arm, wherein after initial movement from a lowered position, the slide block disengages from the cam surface and the slide stops engage the pins for providing vertical movement to the second end of the lift arm.

8. The lift mechanism of claim 7 wherein each slide block includes a roller attached at one end configured to engage the cam surface.

9. The lift mechanism of claim 2 wherein the slide block includes a plurality of guide rollers horizontally mounted to the bottom of the slide block and configured to engage a track positioned on the base.

10. A system for raising and lowering a movable roof on a vehicle, the system comprising:
at least one lift mechanism including
a base mounted on the vehicle;
a drive assembly attached to the base; and
a pair of elevation assemblies attached to the base, each elevation assembly including
a slide block coupled to the drive assembly and configured to move linearly along the base,
a support arm having a first end and a second end, the support arm being pivotally connected to the base at the first end and including a cam surface disposed on the support arm at the second end configured for cooperation with the slide block, and
a lift arm having a first end and a second end, the lift arm being pivotally coupled to the second end of the support arm at a location between the first end of the lift arm and the second end of the lift arm, the first end of the lift arm coupled to the slide block,
wherein the elevation assemblies are configured to operate in synchronism between a lowered position and a raised position to provide substantially vertical movement to an object attached to the second ends of the lift arms without tilting the object, and wherein the elevation assemblies are configured such that upon initial outward movement of the slide blocks, the slide blocks engage the cam surfaces to provide cam-assisted vertical movement to the second ends of the lift arms, and wherein after the initial movement, the slide blocks disengage the cam surfaces and the slide blocks engage the first ends of the lift arms, thereby continuing the vertical movement of the second ends of the lift arms.

11. The system of claim 10 wherein the drive assembly includes a driver coupled to a drive shaft.

12. The system of claim 11 wherein the drive shaft includes a screw thread disposed about the drive shaft, the screw thread configured for cooperation with a bore disposed within the slide block.

13. The system of claim 12 wherein the driver is selected from the group consisting of an electric motor, a pneumatic motor, and a hydraulic motor.

14. The system of claim 10 wherein the slide block includes first and second slots, one slot disposed along each side of the slide block, the first and second slots being configured to receive a first pin and a second pin disposed on the first end of the lift arm for slidable engagement of the slide block and the lift arm.

15. The system of claim 14 including a slide stop positioned within each of the first and second slots on the slide block, each slide stop configured to engage a pin located on the first end of the lift arm, wherein after initial movement from a lowered position, the slide block disengages from the cam surface and the slide stops engage the pins for providing vertical movement to the second end of the lift arm.

16. The system of claim 10 wherein the slide block includes a plurality of guide rollers horizontally mounted to the bottom of the slide block and configured to engage a track positioned on the base.

17. The system of claim 10 wherein the pair of elevation assemblies are disposed in a mirrored configuration relative to each other on opposite ends of the base.

18. The system of claim 10 including a first lift mechanism and a second lift mechanism, the first and second lift mechanisms being mounted to a vehicle apart from each other and adjacent to an opening configured to receive a movable roof.

19. The system of claim 18 wherein the first and second lift mechanisms are configured to operate in synchronism.

20. The system of claim 19 wherein the first lift mechanism is mounted proximate to a forward portion of the vehicle and the second lift mechanism is mounted proximate to an aft portion of the vehicle.

21. The system of claim 19 wherein the first lift mechanism is mounted proximate to a first side of the vehicle and the second lift mechanism is mounted proximate to a second side of the vehicle opposite the first lift mechanism.
